(19) United States
(12) Patent Application Publication
(10) Pub. No.: US 2026/0326919 A1
(43) Pub. Date: Oct. 22, 2026

(54) WORK AERIAL VEHICLE

(71) Applicant: Kubota Corporation, Osaka (JP)

(72) Inventor: Kojiro WATANABE, Sakai-shi (JP)

(21) Appl. No.: 19/696,918

(22) Filed: Jun. 3, 2026

Related U.S. Application Data
(63) Continuation of application No. PCT/JP2023/046982, filed on Dec. 27, 2023.

(51) Int. Cl. B64D 47/00; B64U 10/16; B64U 101/28; F16C 11/06

(52) U.S. Cl. CPC B64D 47/00; B64U 10/16; F16C 11/06; B64U 2101/28

(57) ABSTRACT

A work aerial vehicle includes an aerial vehicle, a work device capable of performing a predetermined operation, and a rod-shaped coupler configured to couple the aerial vehicle and the work device to each other. The rod-shaped coupler includes a swing swingable relative to the aerial vehicle, and the swing is not swingable about an axis extending along an up-down direction of the aerial vehicle, or swinging of the swing about the axis extending along the up-down direction of the aerial vehicle is restricted.

### CROSS REFERENCE TO RELATED APPLICATIONS

This application is a Continuation Application of PCT Application No. PCT/JP2023/046982 filed on Dec. 27, 2023. The entire contents of this application are hereby incorporated herein by reference.

### BACKGROUND OF THE INVENTION

### 1. Field of the Invention

The present invention relates to work aerial vehicles.

### 2. Description of the Related Art

JP2023-83932 A describes a work device that performs a predetermined operation and that is suspended from an unmanned aircraft via a coupling part made of a wire, a cord, a chain, or the like. This work device performs a coating operation on a wall surface in the air while suspended from the unmanned aircraft.

### SUMMARY OF THE INVENTION

In the case of the work device described in JP2023-83932 A, as a result of the unmanned aircraft rotating about a vertical axis, the work device coupled to the unmanned aircraft via the coupling part is also rotated about the vertical axis. Accordingly, it is possible to redirect the work device.

However, since the coupling part is made of a wire, a cord, a chain, or the like, the coupling part may become twisted when the unmanned aircraft rotates about the vertical axis. This may make it difficult for the operator to redirect the work device to an intended direction.

Example embodiments of the present invention provide work aerial vehicles that each allow a work device to be easily redirected to an intended direction.

A work vehicle according to an example embodiment of the present invention includes an aerial vehicle, a work device configured to perform a predetermined operation, and a rod-shaped coupler coupling the aerial vehicle and the work device to each other, the rod-shaped coupler including a swing swingable relative to the aerial vehicle, and the swing not being swingable about an axis extending along an up-down direction of the aerial vehicle, or swinging of the swing about the axis extending along the up-down direction of the aerial vehicle being restricted.

According to an example embodiment of the present invention, as compared with a configuration in which the aerial vehicle and the work device are coupled to each other using a wire, a cord, a chain, or the like, the work device can be easily redirected by redirecting the aerial vehicle about the axis extending along the up-down direction.

The rod-shaped coupler includes the swing. Accordingly, even in a case where shaking occurs in the aerial vehicle when the aerial vehicle is in flight, the shaking of the aerial vehicle is less likely to be transmitted to the work device. Accordingly, the work device coupled to the aerial vehicle is less likely to shake, thus making it easy for the work device to perform the predetermined operation.

In an example embodiment of the present invention, it is preferable that the swing is swingable about an axis extending along a left-right direction of the aerial vehicle, and is swingable about an axis extending along a front-rear direction of the aerial vehicle.

The posture of the aerial vehicle may be inclined forward, rearward, rightward, or leftward by strong wind or the like. In this case, the posture of the work device coupled to the aerial vehicle by the rod-shaped coupler is also inclined forward, rearward, rightward, or leftward. According to an example embodiment of the present invention, even in a case where the aerial vehicle is inclined forward, rearward, rightward, or leftward, the swing makes the posture of the work device less likely to be changed accidentally. This makes it easier for the work device coupled to the aerial vehicle to perform the predetermined operation.

In an example embodiment of the present invention, it is preferable that the rod-shaped coupler includes a first swing located at an end portion of the rod-shaped coupler on an aerial vehicle side as the swing, and a second swing located at an end portion of the rod-shaped coupler on a work device side as the swing.

According to an example embodiment of the present invention, in a case where shaking occurs in the aerial vehicle when the aerial vehicle is in flight, the first swing makes the swinging of the aerial vehicle less likely to be transmitted to the rod-shaped coupler. In a case where shaking occurs in the work device, the second swing makes the shaking of the work device less likely to be transmitted to the rod-shaped coupler. Consequently, the posture of the rod-shaped coupler is maintained. Accordingly, in a case where one of the aerial vehicle and the work device is inclined, the rod-shaped coupler is less likely to be inclined, and therefore the position of the other one of the aerial vehicle and the work device is less likely to be changed by the inclination of the rod-shaped coupler.

In an example embodiment of the present invention, it is preferable that the swing includes a universal joint.

According to an example embodiment of the present invention, even in a case where the aerial vehicle is inclined forward, rearward, rightward, or leftward, the swing makes the posture of the work device less likely to be changed accidentally.

In an example embodiment of the present invention, it is preferable that the rod-shaped coupler is bendable.

When the aerial vehicle is in flight, the rod-shaped coupler may come into contact with an operation target region. When the rod-shaped coupler comes into contact with the operation target region, the impact from the rod-shaped coupler is transmitted to the aerial vehicle, and the posture of the aerial vehicle is likely to be disrupted. According to an example embodiment of the present invention, even in a case where the rod-shaped coupler comes into contact with the operation target region, the rod-shaped coupler is bent, thus making the impact from the rod-shaped coupler less likely to be transmitted to the aerial vehicle. Accordingly, the posture of the aerial vehicle is less likely to be disrupted.

In an example embodiment of the present invention, it is preferable that the rod-shaped coupler is extendable and retractable in a lengthwise direction thereof.

According to an example embodiment of the present invention, even in a case where the rod-shaped coupler comes into contact with the operation target region, the rod-shaped coupler extends and retracts in the lengthwise direction, thus making the impact from the rod-shaped coupler less likely to be transmitted to the aerial vehicle. Accordingly, the posture of the aerial vehicle is less likely to be disrupted.

In an example embodiment of the present invention, it is preferable that, while the aerial vehicle is in flight, the rod-shaped coupler is changeable in posture between an operating posture, in which the rod-shaped coupler extends along the up-down direction of the aerial vehicle, and a storage posture, in which the rod-shaped coupler extends along a front-rear direction of the aerial vehicle.

In a case where the rod-shaped coupler is in the operating posture extending along the up-down direction of the aerial vehicle, the rod-shaped coupler is likely to come into contact with the operation target region during landing of the aerial vehicle. This makes it difficult for the aerial vehicle to land in the operating posture. According to an example embodiment of the present invention, the rod-shaped coupler takes the storage posture extending along the front-rear direction of the aerial vehicle, whereby the rod-shaped coupler is made more compact in the up-down direction than in the operating posture. Accordingly, the rod-shaped coupler is less likely to come into contact with the operation target region during landing of the aerial vehicle, thus making it easy for the aerial vehicle to land.

In an example embodiment of the present invention, it is preferable that the aerial vehicle includes a plurality of rotors, and the rod-shaped coupler is located outside rotation ranges of the rotors in a plan view in the storage posture.

According to an example embodiment of the present invention, in the storage posture, the rod-shaped coupler does not obstruct the air flow generated when the rotor is driven, and therefore the aerial vehicle can fly stably.

In an example embodiment of the present invention, it is preferable that the aerial vehicle includes a winch configured to wind a wire connected to the rod-shaped coupler, and the rod-shaped coupler is brought into the storage posture from the operating posture by the wire being wound up by the winch.

According to an example embodiment of the present invention, the posture change of the rod-shaped coupler can be easily performed using the winch.

In an example embodiment of the present invention, it is preferable that the work aerial vehicle further includes a harness extending between the aerial vehicle and the work device, wherein the harness is routed along the rod-shaped coupler.

According to an example embodiment of the present invention, the harness that connects the aerial vehicle and the work device to each other can be easily routed along the rod-shaped coupler.

In an example embodiment of the present invention, it is preferable that the rod-shaped coupler includes an accommodating section configured to accommodate an electric component or an agricultural material, and the accommodating section is fixed at a position different from the work device in a lengthwise direction of the rod-shaped coupler.

According to an example embodiment of the present invention, the accommodating section can be provided in the rod-shaped coupler at a position at which the accommodating section is less likely to interfere with the work device.

In an example embodiment of the present invention, it is preferable that the accommodating section is fixed to the rod-shaped coupler in a posture in which a lengthwise direction of the accommodating section extends along the rod-shaped coupler.

According to an example embodiment of the present invention, the accommodating member can be stably supported by the rod-shaped coupler.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view showing a work aerial vehicle whose rod-shaped coupler is in an operating posture.

FIG. 2 is a left side view showing the work aerial vehicle whose rod-shaped coupler is in a storage posture.

FIG. 3 is a front view showing the work aerial vehicle whose rod-shaped coupler is in the operating posture.

FIG. 4 is a plan view showing the work aerial vehicle whose rod-shaped coupler is in the storage posture.

FIG. 5 is a block diagram showing the work aerial vehicle.

FIG. 6 is a left side view showing another example of the work aerial vehicle whose rod-shaped coupler is in the operating posture.

FIG. 7 is a front view showing another example of the work aerial vehicle whose rod-shaped coupler is in the operating posture.

FIG. 8 is a plan view showing another example of the work aerial vehicle whose rod-shaped coupler is in the storage posture.

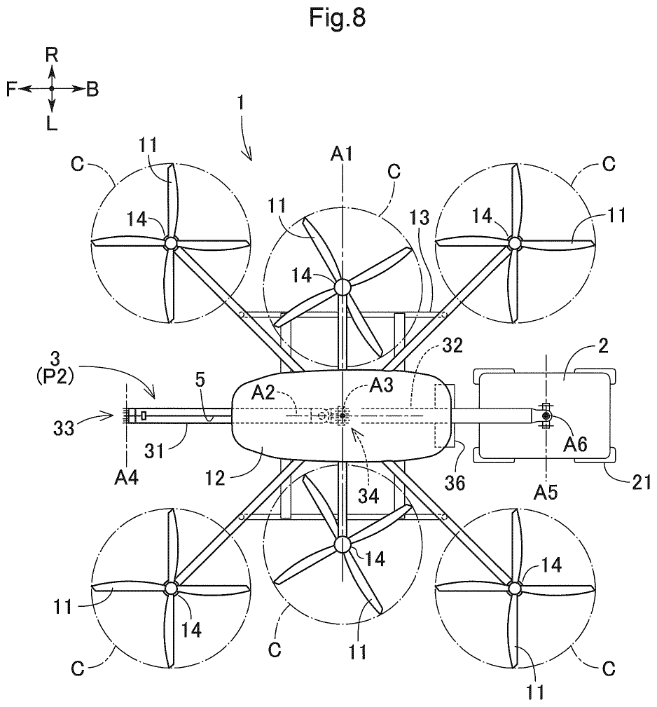

### DETAILED DESCRIPTION OF THE EXAMPLE EMBODIMENTS

Work aerial vehicles according to example embodiments of the present invention will be described below with reference to the drawings. Note that, in the following description, the direction indicated by the arrow F in the drawings is defined as a “front side”, the direction indicated by the arrow B is defined as a “rear side”, the direction indicated by the arrow U is defined as an “upper side”, the direction indicated by the arrow D is defined as a “lower side”, the direction indicated by the arrow R is defined as a “right side”, and the direction indicated by the arrow L is defined as a “left side”.

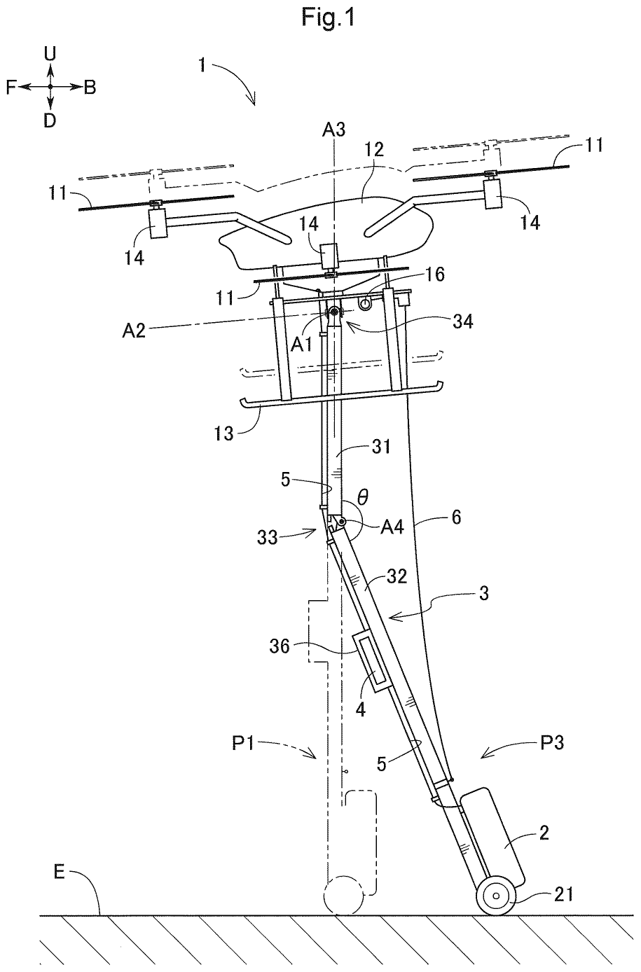

As shown in FIG. 1, a work aerial vehicle according to an example embodiment of the present invention includes an aerial vehicle 1, a work device 2 capable of performing a predetermined operation, and a rod-shaped coupler 3 that couples the aerial vehicle 1 and the work device 2 to each other. The aerial vehicle 1 is coupled to an upper portion of the rod-shaped coupler 3, and the work device 2 is coupled to a lower portion of the rod-shaped coupler 3.

The aerial vehicle 1 is capable of autonomous flight or flight through remote control using a remote controller or the like. The aerial vehicle 1 is an unmanned aircraft that cannot be boarded by a person due to its structure. In the present example embodiment, the aerial vehicle 1 is a drone including a plurality of rotors 11. Example embodiments of the present invention are not limited thereto, and the aerial vehicle 1 may be an unmanned helicopter or the like, for example.

The work device 2 performs the predetermined operation while in contact with the ground in an operation target region E. The work device 2 cannot be boarded by a person due to its structure, and does not include a driving section on which an operator rides. In the present example embodiment, the work device 2 preferably is a sowing device that performs a crop sowing operation, for example. The work device 2 includes wheels 21 for moving in the operation target region E while being towed by the aerial vehicle 1. Example embodiments of the present invention are not limited thereto, and the work device 2 may include a travel device, and the wheels 21 may be driven. The work device 2 need not perform the predetermined operation while in contact with the ground in the operation target region E, and need not include the wheels 21.

The operation target region E is a region in which the work device 2 performs the operation. The operation target region E may be a field, a region around a field, a forest, or the like.

The rod-shaped coupler 3 includes a first swing 34 (corresponding to a swing) capable of swinging relative to the aerial vehicle 1. The first swing 34 includes a universal joint.

The first swing 34 is swingable about an axis A1 (pitch direction) extending along the left-right direction of the aerial vehicle 1, and is swingable about an axis A2 (roll direction) extending along the front-rear direction of the aerial vehicle 1. The first swing 34 does not swing about an axis A3 (yaw direction) extending along the up-down direction of the aerial vehicle 1.

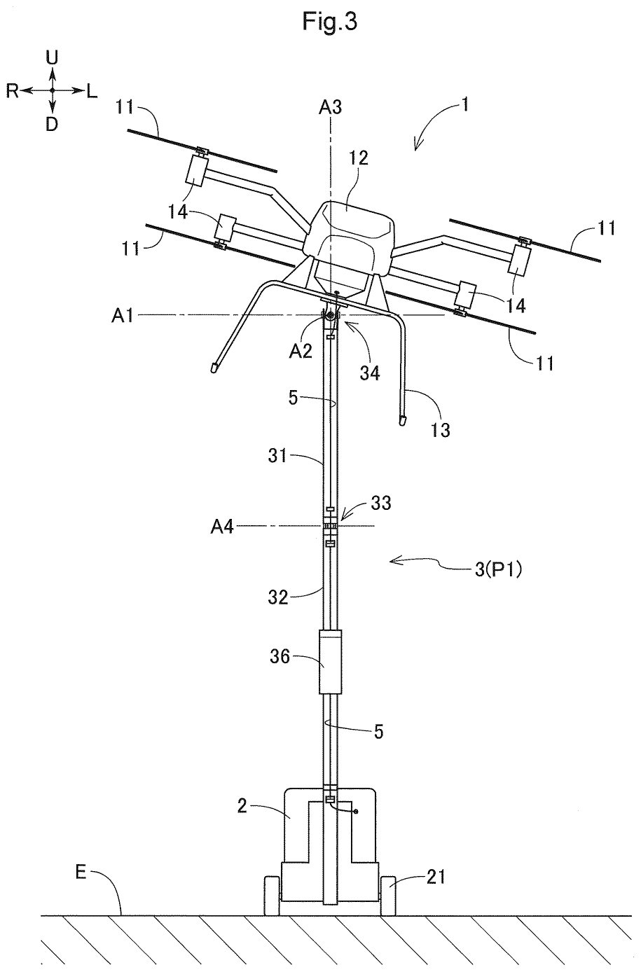

In a case where the aerial vehicle 1 is in a posture inclined downwardly to the left as shown in FIG. 3, the first swing 34 swings about the axis A2. Thus, the posture of the work device 2 remains unchanged even in a case where the aerial vehicle 1 accidentally becomes inclined due to wind or the like. Accordingly, the work device 2 is less likely to be affected by an accidental posture change of the aerial vehicle 1.

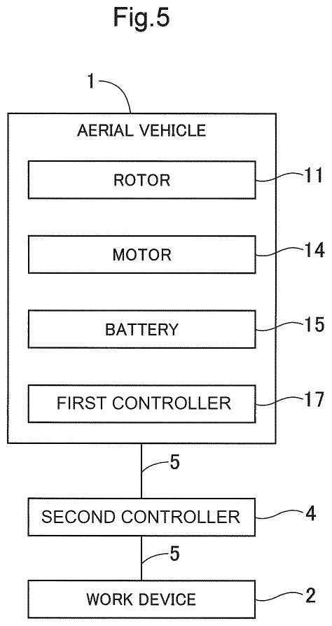

As shown in FIGS. 1 and 5, the aerial vehicle 1 includes a vehicle body 12, a skid 13 provided below the vehicle body 12, a plurality of motors 14 that drive the rotors 11, a battery 15 that supplies power to the motors 14, and a first controller 17 configured or programmed to control the aerial vehicle 1.

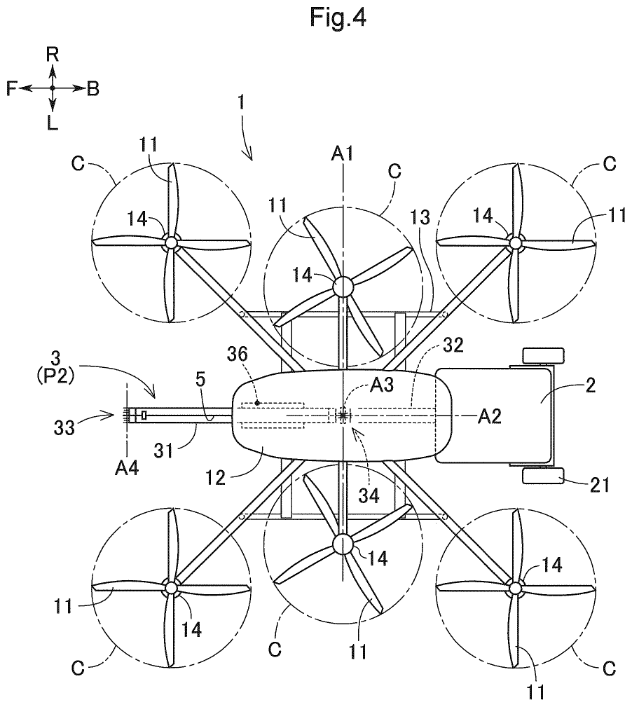

As shown in FIG. 4, each of the rotors 11 includes a rotary vane that rotates about an axis extending in the up-down direction. A plurality of rotors 11 are arranged in the front-rear direction on the right side relative to the vehicle body 12. Also, a plurality of rotors 11 are arranged in the front-rear direction on the left side relative to the vehicle body 12.

A plurality of rotors 11 are arranged in the left-right direction on the front side relative to the vehicle body 12. Also, a plurality of rotors 11 are arranged in the left-right direction on the rear side relative to the vehicle body 12.

In the present example embodiment, six rotors 11 are provided, for example. Example embodiments of the present invention are not limited thereto, and the number of the rotors 11 may be less than six, or may be seven or more.

As shown in FIG. 1, the skid 13 includes a plurality of vertical structures extending in a direction away from the vehicle body 12, and a coupler that couples the plurality of vertical structures to each other.

The first controller 17 include a storage and a CPU that executes a program. The storage may be, for example, an HDD, a ROM, a nonvolatile memory, or the like.

The motors 14 are located at proximal end portions of the plurality of rotors 11. The rotors 11 are driven by rotation of the motors 14. In FIG. 4, the dash-dot line indicates a rotation range C of each of the rotors 11.

As shown in FIG. 1, the rod-shaped coupler 3 includes a first portion 31 located on the aerial vehicle 1 side, a second portion 32 located on the work device 2 side relative to the first portion 31, a bending section 33 that enables the second portion 32 to be bent relative to the first portion 31 about an axis A4 extending along the left-right direction of the aerial vehicle 1, and an accommodating section 36 capable of accommodating an electric component or an agricultural material.

In the present example embodiment, the rod-shaped coupler 3 is made of steel, for example. Example embodiments of Example embodiments of the present invention are not limited thereto, and the rod-shaped coupler 3 may be made of any other metal such as stainless steel.

The rod-shaped coupler 3 is a cross-sectionally square structure configured to be bendable by the bending section 33. Example embodiments of the present invention are not limited thereto, and the rod-shaped coupler 3 may have any shape. For example, the rod-shaped coupler 3 may be circular in a cross-sectional view.

The first swing 34 is located at an end portion of the rod-shaped coupler 3 on the aerial vehicle 1 side. In other words, the first swing 34 is located at a portion connected to the aerial vehicle 1. The first swing 34 is provided at the first portion 31. Example embodiments of the present invention are not limited thereto, and the first swing 34 may be located at any position of the rod-shaped coupler 3 between the end portion on the aerial vehicle 1 side and the bending section 33.

As shown in FIG. 1, the accommodating section 36 has a box shape. The accommodating section 36 accommodates a second controller 4 that controls the work device 2. Example embodiments of the present invention are not limited thereto, and the accommodating section 36 may have any shape. For example, the accommodating section 36 may have a cylindrical shape.

The accommodating section 36 is provided at the second portion 32. The accommodating section 36 is fixed to the rod-shaped coupler 3 at a position different from the work device 2 in the lengthwise direction. Specifically, the accommodating section 36 is fixed on the bending section 33 side relative to the work device 2 in the lengthwise direction of the rod-shaped coupler 3. In addition, the accommodating section 36 is located opposite to the work device 2 in the widthwise direction of the rod-shaped coupler 3.

In the present example embodiment, the accommodating section 36 is fixed to the rod-shaped coupler 3 in a posture in which the lengthwise direction of the accommodating section 36 extends along the lengthwise direction of the rod-shaped coupler 3.

A harness 5 extending between the aerial vehicle 1 and the work device 2 is routed along the rod-shaped coupler 3. The harness 5 extends from the aerial vehicle 1 to the second controller 4 inside the accommodating section 36. In addition, the harness 5 extends from the second controller 4 to the work device 2.

The second controller 4 includes a storage and a CPU that executes a program. The storage is configured, for example, by an HDD, a ROM, a nonvolatile memory, or the like. As shown in FIG. 4, the second controller 4 is configured or programmed to transmit and receive information to and from the work device 2 via the harness 5. In addition, power is supplied to the second controller 4 from the battery 15 of the aerial vehicle 1 via the harness 5.

The work device 2 is connected to the aerial vehicle 1 via the harness 5. This enables the work device 2 to transmit and receive information to and from the aerial vehicle 1 or to input and output power to and from the aerial vehicle 1.

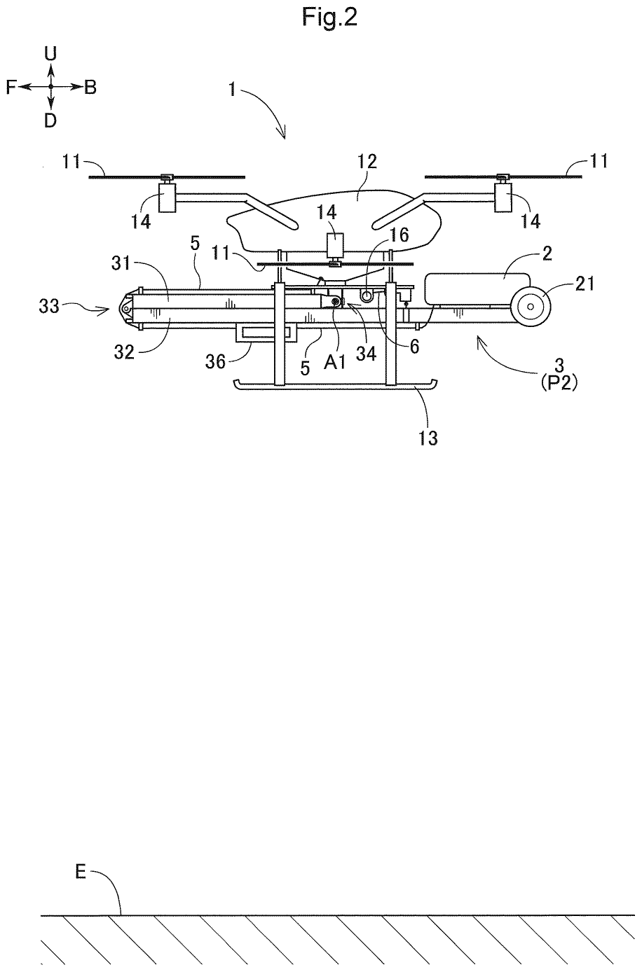

As shown in FIGS. 1 and 2, when the aerial vehicle 1 is in flight, the rod-shaped coupler 3 is changeable in posture between a first operating posture P1 (corresponding to an operating posture) extending along the up-down direction of the aerial vehicle 1, and a storage posture P2 extending along the front-rear direction of the aerial vehicle 1.

In FIG. 1, the dashed double-dotted line indicates the first operating posture P1 of the rod-shaped coupler 3. In the first operating posture P1, the first portion 31 and the second portion 32 are collinear with each other. FIG. 2 shows the storage posture P2 of the rod-shaped coupler 3.

The aerial vehicle 1 includes a winch 16 capable of winding up a wire 6 connected to the rod-shaped coupler 3, and the rod-shaped coupler 3 is brought into the storage posture P2 from the first operating posture P1 as a result of the wire 6 being wound up by the winch 16.

Specifically, while the rod-shaped coupler 3 is in the first operating posture P1, the first controller 17 is configured or programmed to cause a motor included in the winch 16 to be driven in one direction. Consequently, the wire 6 is wound up, and the first portion 31 of the rod-shaped coupler 3 is swung forward about the axis A1. In addition, the second portion 32 is swung rearward about the axis A4. This brings the rod-shaped coupler 3 into the storage posture P2.

While the rod-shaped coupler 3 is in the storage posture P2, the first controller 17 is configured or programmed to cause the motor included in the winch 16 to be driven in the other direction. This causes the wire 6 to extend, whereby the second portion 32 of the rod-shaped coupler 3 is swung forward about the axis A4. In addition, the first portion 31 of the rod-shaped coupler 3 is swung rearward about the axis A1. This brings the rod-shaped coupler 3 into the first operating posture P1.

As shown in FIG. 4, when the rod-shaped coupler 3 has been brought into the storage posture P2, the accommodating section 36 is located forward of the work device 2. Accordingly, as compared with a case where the accommodating section 36 is fixed at the same position as the work device 2 in the lengthwise direction of the rod-shaped coupler 3, the weight balance in the front-rear direction is maintained when the rod-shaped coupler 3 has been brought into the storage posture P2.

While the rod-shaped coupler 3 is in the first operating posture P1, the accommodating section 36 is located opposite to the direction in which the second portion 32 swings when the rod-shaped coupler 3 is brought into the storage posture P2. Specifically, while the rod-shaped coupler 3 is in the first operating posture P1, the accommodating section 36 is fixed to a front surface of the rod-shaped coupler 3. Accordingly, when the rod-shaped coupler 3 has been brought into the storage posture P2, the accommodating section 36 is less likely to interfere with the first portion 31.

The harness 5 is routed on a side opposite to the wire 6 across the rod-shaped coupler 3. Accordingly, when the rod-shaped coupler 3 has been changed in posture from the first operating posture P1 to the storage posture P2, the harness 5 is less likely to get entangled with the wire 6 wound up by the winch 16.

As shown in FIG. 4, the rod-shaped coupler 3 is located outside the rotation ranges C of the rotors 11 in the storage posture P2 in a plan view. The rod-shaped coupler 3 is located between the rotors 11 located rightward of the vehicle body 12, and the rotors 11 located leftward of the vehicle body 12. Specifically, the rod-shaped coupler 3 extends in the front-rear direction at a position at which the rod-shaped coupler 3 overlaps the vehicle body 12 in the storage posture P2.

The second portion 32 is longer in the lengthwise direction than the first portion 31. Specifically, the length in the lengthwise direction of the second portion 32 is approximately twice that of the first portion 31. Accordingly, in the storage posture P2, the weight balance between the weight of the portion of the rod-shaped coupler 3 that is located forward of the vehicle body 12, and the weight of the portion of the rod-shaped coupler 3 that is located rearward of the vehicle body 12 is easily maintained.

In FIG. 1, the solid line indicates a second operating posture P3 of the rod-shaped coupler 3. As shown in FIG. 1, while the rod-shaped coupler 3 is in the first operating posture P1, in which the first portion 31 extends in the up-down direction, the second portion 32 is bent rearward about the axis A4 by the bending section 33. This brings the rod-shaped coupler 3 into the second operating posture P3 (corresponding to an operating posture) from the first operating posture P1. At this time, an angle θ formed between the first portion 31 and the second portion 32 in a side view is an obtuse angle. In the second operating posture P3, the aerial vehicle 1 can fly at a position ahead of the work device 2, and therefore the work device 2 can be easily towed by the aerial vehicle 1.

The present invention is not limited to the above-described example embodiments. For example, the present invention may be configured as described in the following alternative example embodiments. In the alternative example embodiments described below, the same configurations as those of the above example embodiments are denoted by the same reference numerals and signs as those of the above examples.

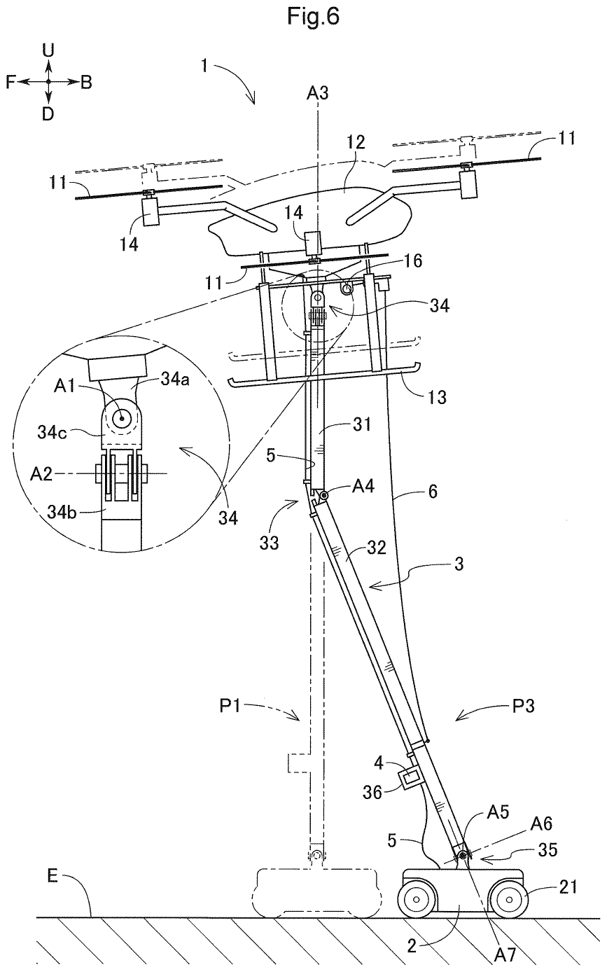

In the above-described example embodiments, the work device 2 is a sowing device. Example embodiments of the present invention are not limited thereto, and the work device 2 may have a different configuration. For example, as shown in FIG. 6, the work device 2 may be a mowing device that mows grass in the operation target region E. Also, the work device 2 may be a cultivating device, an agricultural chemical spraying device, a fertilizing device, a grass collecting device, a harvesting device, or the like.

As shown in FIG. 6, the rod-shaped coupler 3 may include a second swing 35 (corresponding to a swing) swingable relative to the aerial vehicle 1. The second swing 35 includes a universal joint.

The second swing 35 is swingable about an axis A5 (pitch direction) extending along the left-right direction of the aerial vehicle 1, and is swingable about an axis A6 (roll direction) extending along the front-rear direction of the aerial vehicle 1. In addition, the second swing 35 does not swing about an axis A7 (yaw direction) extending along the up-down direction of the aerial vehicle 1.

The second swing 35 is located at an end portion of the rod-shaped coupler 3 on the work device 2 side. In other words, the second swing 35 is located at a portion connected to the work device 2. The second swing 35 is provided at the second portion 32. Example embodiments of the present invention are not limited thereto, and the second swing 35 may be located at any position of the rod-shaped coupler 3 between the end portion thereof on the work device 2 side and the bending section 33.

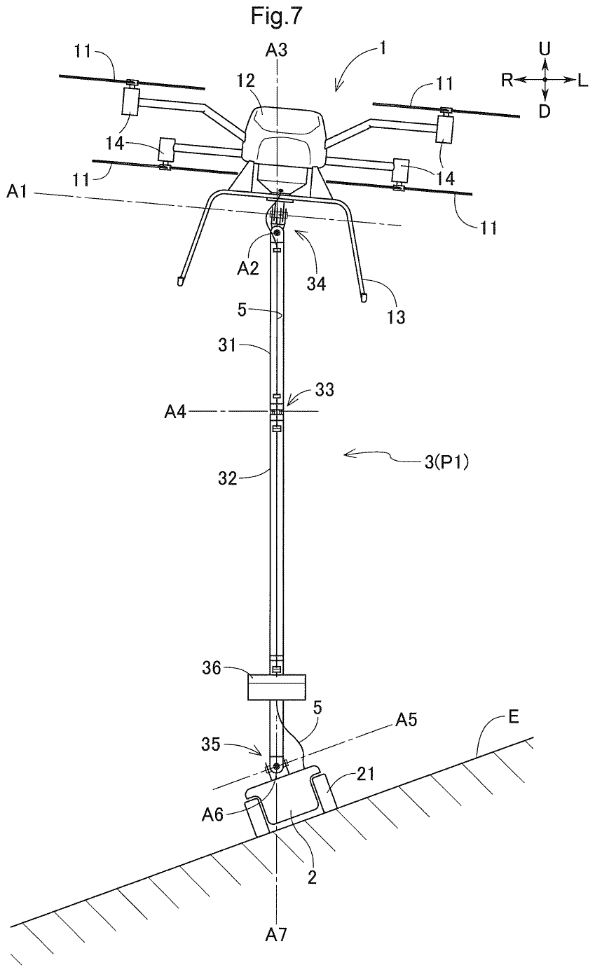

As shown in FIG. 7, in a case where the operation target region E is an inclined ground surface, the work device 2 may be in a posture inclined relative to the horizontal plane. In the present example embodiment, the work device 2 is in a posture inclined downwardly to the left. Since the second swing 35 is swingable about the axis A6, the work device 2 can perform an operation while the aerial vehicle 1 is located directly above the work device 2.

In the above-described example embodiments, the first swing 34 and the second swing 35 each preferably include a universal joint. Example embodiments of the present invention are not limited thereto, and at least one of the first swing 34 and the second swing 35 may have a different configuration. For example, as shown in FIG. 6, the first swing 34 may include a first connector 34a, a second connector 34b, and a third connector 34c.

An end portion of the first connector 34a on the work device 2 side is swingable about the axis A1 relative to an end portion of the second connector 34b on the aerial vehicle 1 side. The end portion of the second connector 34b on the aerial vehicle 1 side is swingable about the axis A2 relative to an end portion of the third connector 34c on the work device 2 side.

At least one of the first swing 34 and the second swing 35 may be swingable about the axes A3 and A7 extending along the up-down direction of the aerial vehicle 1. In this case, at least one of the first swing 34 and the second swing 35 includes a motor.

In a case where the rod-shaped coupler 3 is in the storage posture P2, the first controller 17 causes the rod-shaped coupler 3 to swing about the axes A3 and A7 relative to the aerial vehicle 1 using the motor. In a case where the rod-shaped coupler 3 is in the first operating posture P1 or the second operating posture P3, the first controller 17 does not cause the rod-shaped coupler 3 to swing about the axes A3 and A7 relative to the aerial vehicle 1 using the motor. In other words, in a case where the rod-shaped coupler 3 is in the first operating posture P1, swinging of at least one of the first swing 34 and the second swing 35 about the axes A3 and A7 may be restricted.

The rod-shaped coupler 3 may be configured in such a manner that the bending section 33 enables the second portion 32 to be bent forward about the axis A4.

The rod-shaped coupler 3 may be configured to be extendable and retractable along the lengthwise direction of the rod-shaped coupler 3.

As shown in FIG. 7, the accommodating section 36 may be fixed to the rod-shaped coupler 3 in a posture in which the lengthwise direction of the accommodating section 36 is oriented in a direction orthogonal to the lengthwise direction of the rod-shaped coupler 3.

The accommodating section 36 may accommodate a battery that supplies power to the aerial vehicle 1 or the work device 2. Also, the accommodating section 36 may accommodate an agricultural material therein. For example, in a case where the work device 2 is a sowing device, the agricultural material may be crop seeds.

The second controller 4 may be provided in the work device 2. In this case, the harness 5 may directly connect the aerial vehicle 1 and the work device 2 to each other.

The accommodating section 36 may be fixed to the same position as the work device 2 in the lengthwise direction of the rod-shaped coupler 3, and be located opposite to the work device 2 in the widthwise direction of the rod-shaped coupler 3.

In the above-described example embodiments, the aerial vehicle 1 includes the winch 16 capable of winding up the wire 6 connected to the rod-shaped coupler 3. Example embodiments of the present invention are not limited thereto, and the rod-shaped coupler 3 may include a winch 16 capable of winding up the wire 6 connected to the aerial vehicle 1.

While the rod-shaped coupler 3 is in the first operating posture P1, the first controller 17 causes the motor included in the first swing 34 to be driven to one side. Accordingly, the first portion 31 of the rod-shaped coupler 3 is swung forward about the axis A1. In addition, the first controller 17 causes the motor provided in the winch 16 to be driven. Consequently, the wire 6 may be wound up, whereby the second portion 32 may be swung rearward about the axis A4. Example embodiments of the present invention are not limited thereto, and the first portion 31 of the rod-shaped coupler 3 may be swung forward about the axis A1 by extension/retraction of an actuator.

The rod-shaped coupler 3 may be a tubular structure having a space therein. In this case, the harness 5 may be routed inside the rod-shaped coupler 3 along the lengthwise direction of the rod-shaped coupler 3.

Example embodiments of the present invention are applicable to aerial vehicles that perform a predetermined operation.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work aerial vehicle comprising:
an aerial vehicle;
a work device configured to perform a predetermined operation; and
a rod-shaped coupler coupling the aerial vehicle and the work device to each other;
the rod-shaped coupler including a swing swingable relative to the aerial vehicle; and
the swing not being swingable about an axis extending along an up-down direction of the aerial vehicle, or swinging of the swing about the axis extending along the up-down direction of the aerial vehicle being restricted.

2. The work aerial vehicle according to claim 1, wherein the swing is swingable about an axis extending along a left-right direction of the aerial vehicle, and is swingable about an axis extending along a front-rear direction of the aerial vehicle.

3. The work aerial vehicle according to claim 1, wherein the rod-shaped coupler includes a first swing located at an end portion of the rod-shaped coupler on an aerial vehicle side as the swing, and a second swing located at an end portion of the rod-shaped coupler on a work device side as the swing.

4. The work aerial vehicle according to claim 1, wherein the swing includes a universal joint.

5. The work aerial vehicle according to claim 1, wherein the rod-shaped coupler is bendable.

6. The work aerial vehicle according to claim 1, wherein the rod-shaped coupler is extendable and retractable in a lengthwise direction.

7. The work aerial vehicle according to claim 5, wherein, while the aerial vehicle is in flight, the rod-shaped coupler is changeable in posture between an operating posture, in which the rod-shaped coupler extends along the up-down direction of the aerial vehicle, and a storage posture, in which the rod-shaped coupler extends along a front-rear direction of the aerial vehicle.

8. The work aerial vehicle according to claim 7, wherein
the aerial vehicle includes a plurality of rotors; and
the rod-shaped coupler is located outside rotation ranges of the rotors in a plan view in the storage posture.

9. The work aerial vehicle according to claim 7, wherein
the aerial vehicle includes a winch configured to wind a wire connected to the rod-shaped coupler; and
the rod-shaped coupler is brought into the storage posture from the operating posture by the wire being wound up by the winch.

10. The work aerial vehicle according to claim 1, further comprising:
a harness extending between the aerial vehicle and the work device; wherein
the harness is routed along the rod-shaped coupler.

11. The work aerial vehicle according to claim 1, wherein
the rod-shaped coupler includes an accommodating section configured to accommodate an electric component or an agricultural material; and
the accommodating section is fixed at a position different from the work device in a lengthwise direction of the rod-shaped coupler.

12. The work aerial vehicle according to claim 11, wherein the accommodating section is fixed to the rod-shaped coupler in a posture in which a lengthwise direction of the accommodating section extends along the rod-shaped coupler.
